(19) United States
(12) Patent Application Publication
(10) Pub. No.: US 2026/0179300 A1
(43) Pub. Date: Jun. 25, 2026

(54) SYSTEMS AND METHODS FOR DEVELOPING GENERATIVE ANIMATION VIA ARTIFICIAL INTELLIGENCE

(71) Applicant: Netflix, Inc., Los Gatos, CA (US)

(72) Inventors: Yiwei Zhao, Los Gatos, CA (US); Tianyi Xie, Los Gatos, CA (US)

(21) Appl. No.: 19/388,104

(22) Filed: Nov. 13, 2025

Related U.S. Application Data
(60) Provisional application No. 63/720,730, filed on Nov. 14, 2024.

(51) Int. Cl. G06T 13/80; G06T 11/00

(52) U.S. Cl. CPC G06T 13/80; G06T 11/00

(57) ABSTRACT

An exemplary system for developing generative animation via AI includes one or more storage devices configured to store a static illustration of at least one object. The exemplary system also includes circuitry configured to (1) generate a mesh representation of a segment of the object in the static illustration, (2) simulate motion of the mesh representation by generating a sequence of optical flow fields, (3) extract an initial outline sketch of the object from the static illustration, (4) generate a set of outline sketches that represent the simulated motion by warping the initial outline sketch based at least in part on the sequence of optical flow fields, and (5) apply an AI model to transform the set of outline sketches into a sequence of animation frames that collectively demonstrate the simulated motion. Various other methods, systems, and computer-readable media are also disclosed.

### CROSS REFERENCE TO RELATED APPLICATION

This application claims the benefit of U.S. Provisional Application No. 63/720,730 filed Nov. 14, 2024, the disclosure of which is incorporated in its entirety by this reference.

### BACKGROUND

Producing high-quality animation from static illustrations presents significant challenges in both artistic labor and technical execution. Some conventional animation techniques require skilled artists to manually create each frame—a process that can be time-consuming, costly, and/or difficult to scale. While some technologies attempt to automate aspects of animation, these technologies frequently output animation that lacks physical believability and/or fails to preserve the stylistic integrity of the original artwork. In some cases, these limitations are compounded by the complexity of simulating realistic motion in stylized illustrations like those found in anime and other hand-drawn art forms.

Moreover, some conventional animation technologies can struggle to reconcile the geometric structure of animated objects with the color and texture of the source illustration, potentially leading to inconsistent and/or unsatisfactory results. As a result, artists and content creators can be constrained by the lack of flexible, controllable, and/or high-fidelity animation tools for static illustrations. The instant disclosure, therefore, identifies and addresses a need for improved systems and methods capable of generating dynamic, stylistically consistent animation from static illustrations by integrating physics-based simulation and artificial intelligence (AI).

### SUMMARY

As will be described in greater detail below, the present disclosure describes systems and methods for developing generative animation via AI. In some examples, a system for accomplishing such a task includes one or more storage devices configured to store a static illustration of at least one object. In such examples, the system also includes circuitry configured to (1) generate a mesh representation of a segment of the object in the static illustration, (2) simulate motion of the mesh representation by generating a sequence of optical flow fields, (3) extract an initial outline sketch of the object from the static illustration, (4) generate a set of outline sketches that represent the simulated motion by warping the initial outline sketch based at least in part on the sequence of optical flow fields, and (5) apply an AI model to transform the set of outline sketches into a sequence of animation frames that collectively demonstrate the simulated motion.

In some examples, the circuitry is further configured to receive input indicating one or more external forces to be applied to the mesh representation. In such examples, the circuitry is further configured to simulate the motion of the mesh representation by applying, to the mesh representation, a model of deformable body dynamics that accounts for the input and then generating the sequence of optical flow fields based at least in part on an output of the model of deformable body dynamics. In one example, the input further indicates one or more rigging points of the object, and the external forces include wind, gravity, and/or user-defined energy strokes.

In some examples, the circuitry is further configured to analyze the static illustration to separate a plurality of segments of the object relative to one another and/or to generate a first two-dimensional triangulated mesh representation of a first segment included in the plurality of segments. In one example, the circuitry is further configured to generate a second two-dimensional triangulated mesh representation of a second segment included in the plurality of segments.

In some examples, the circuitry is further configured to simulate motion of the first two-dimensional triangulated mesh representation by generating a first sequence of optical flow fields. In one example, the circuitry is further configured to generate a first set of outline sketches that represent the simulated motion of the first two-dimensional triangulated mesh representation by warping the initial outline sketch based at least in part on the first sequence of optical flow fields. In this example, the circuitry is further configured to apply the AI model to transform the first set of outline sketches into a first sequence of animation frames that collectively demonstrate the simulated motion of the first two-dimensional triangulated mesh representation.

In some examples, the circuitry is further configured to simulate motion of the second two-dimensional triangulated mesh representation by generating a second sequence of optical flow fields. In one example, the circuitry is further configured to generate a second set of outline sketches that represent the simulated motion of the second two-dimensional triangulated mesh representation by warping the initial outline sketch based at least in part on the second sequence of optical flow fields. In this example, the circuitry is further configured to apply the AI model to transform the second set of outline sketches into a second sequence of animation frames that collectively demonstrate the simulated motion of the second two-dimensional triangulated mesh representation.

In some examples, the circuitry is further configured to interpolate at least one additional frame based at least in part on the sequence of animation frames. In one example, the circuitry is further configured to place the additional frame between two frames included in the sequence of animation frames to enhance fluidity of animation. In certain implementations, the circuitry is further configured to apply a cartoon interpolation model to introduce non-physical dynamics that do not follow physical laws in the sequence of animation frames and/or expressive dynamics that show exaggerated motion in the sequence of animation frames.

In some examples, the circuitry is further configured to apply a Gaussian blur to the set of outline sketches to address one or more segmentation inaccuracies. In one example, the circuitry is further configured to extract the initial outline sketch from the static illustration such that the initial outline sketch is void of color and texture present in the static illustration. Additionally or alternatively, the circuitry is configured to generate the set of outline sketches as a texture-agnostic video sequence devoid of the color and texture present in the static illustration. In certain implementations, the AI model is trained on a sample set of anime data, and the sequence of animation frames is characterized by an anime style of animation.

In some examples, a corresponding method involves (1) generating, by circuitry, a mesh representation of a segment of the object in the static illustration, (2) simulating, by the circuitry, motion of the mesh representation by generating a sequence of optical flow fields, (3) extracting, by the circuitry, an initial outline sketch of the object from the static illustration, (4) generating, by the circuitry, a set of outline sketches that represent the simulated motion by warping the initial outline sketch based at least in part on the sequence of optical flow fields, and (5) applying, by the circuitry, an AI model to transform the set of outline sketches into a sequence of animation frames that collectively demonstrate the simulated motion.

In some examples, a non-transitory computer-readable medium comprises one or more computer-executable instructions that, when executed by circuitry of at least one computing device, cause the computing device to (1) generate a mesh representation of a segment of the object present in a static illustration, (2) simulate motion of the mesh representation by generating a sequence of optical flow fields, (3) extract an initial outline sketch of the object from the static illustration, (4) generate a set of outline sketches that represent the simulated motion by warping the initial outline sketch based at least in part on the sequence of optical flow fields, and (5) apply an AI model to transform the set of outline sketches into a sequence of animation frames that collectively demonstrate the simulated motion.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an exemplary system for developing generative animation via AI in accordance with one or more implementations of this disclosure.

FIG. 2 illustrates an exemplary system for developing generative animation via AI in accordance with one or more implementations of this disclosure.

FIG. 3 illustrates an exemplary implementation of developing generative animation via AI in accordance with one or more implementations of this disclosure.

FIG. 4 illustrates an exemplary implementation of developing generative animation via AI in accordance with one or more implementations of this disclosure.

FIG. 5 illustrates an exemplary implementation of developing generative animation via AI in accordance with one or more implementations of this disclosure.

FIG. 6 illustrates an exemplary implementation of developing generative animation via AI in accordance with one or more implementations of this disclosure.

FIG. 7 illustrates an exemplary method for developing generative animation via AI in accordance with one or more implementations of this disclosure.

FIG. 8 illustrates a block diagram of an exemplary content distribution ecosystem.

FIG. 9 illustrates a block diagram of an exemplary distribution infrastructure within the content distribution ecosystem shown in FIG. 8.

FIG. 10 illustrates a block diagram of an exemplary content player within the content distribution ecosystem shown in FIG. 9.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Manual frame-by-frame animation is often labor-intensive, expensive, and difficult to scale due to limitations on artists' skills and time. In some cases, automated tools have been used to produce these frame-by-frame animations. However, these automated tools often produce animations that lack realistic motion, pulling the viewer out of what would otherwise be an immersive and enjoyable experience. Moreover, these auto-generated animations often fail to maintain the style of a target artform such as anime. In view of these technical problems, this paper presents a system for developing generative animation that both expresses realistic motion and maintains the style of target artforms via AI.

For example, a generative animation system can use AI to turn a single, static illustration like an anime drawing into a fully animated sequence, thus simplifying the animation process and making it more flexible than traditional animation options. The system starts by examining the static illustration to identify the main object or character. The system then creates a digital mesh (e.g., a kind of wireframe made of triangles) that represents the shape of that object or character in two dimensions.

Next, the system simulates how the object would move if it were affected by influences like wind, gravity, and/or user-drawn motion lines. This simulation produces a set of motion instructions that show how to capture realistic, stylized motion of each part of the mesh over time. The system then extracts a simple outline of the object from the original illustration, ignoring all color and texture. Using the motion instructions, the system warps (e.g., bends, deforms, twists, etc.) the outline to create a series of sketches that show the object moving frame by frame. For example, the system can bend, deform, and/or twist the shape of the outline to create the series of sketches by shifting the position of points or pixels included in the outline based on the motion instructions. If the object has multiple parts (e.g., arms or hair), the system can handle each part separately to simulate and animate them on their own before combining the resulting individual animations into an integrated form.

The system also implements an AI model that takes these moving sketches and the original illustration as inputs. The AI model uses the original illustration to add color and style to each frame and to ensure that the animation matches the look and feel of the original artwork. The system can also rely on user-specified anchor points to control how certain parts of the object move or stay fixed. To make the resulting animation even smoother, the system can automatically create and introduce extra frames between the main ones.

In some examples, the system can add special cartoon-like effects like exaggerated or unrealistic motion to make the animation more expressive or hyperbolic. In addition, if there are any rough edges or mistakes from the earlier steps, the system can apply a blurring effect to clean or smooth things up. Overall, this system gives artists and creators a powerful tool to quickly and easily turn static illustrations into high-quality, animated sequences that stay true to the original style and provide for a high degree of creative control.

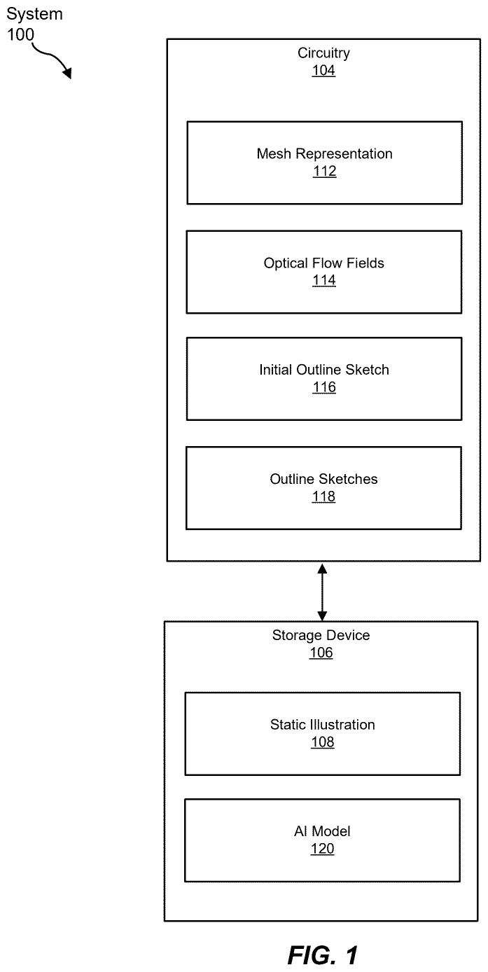

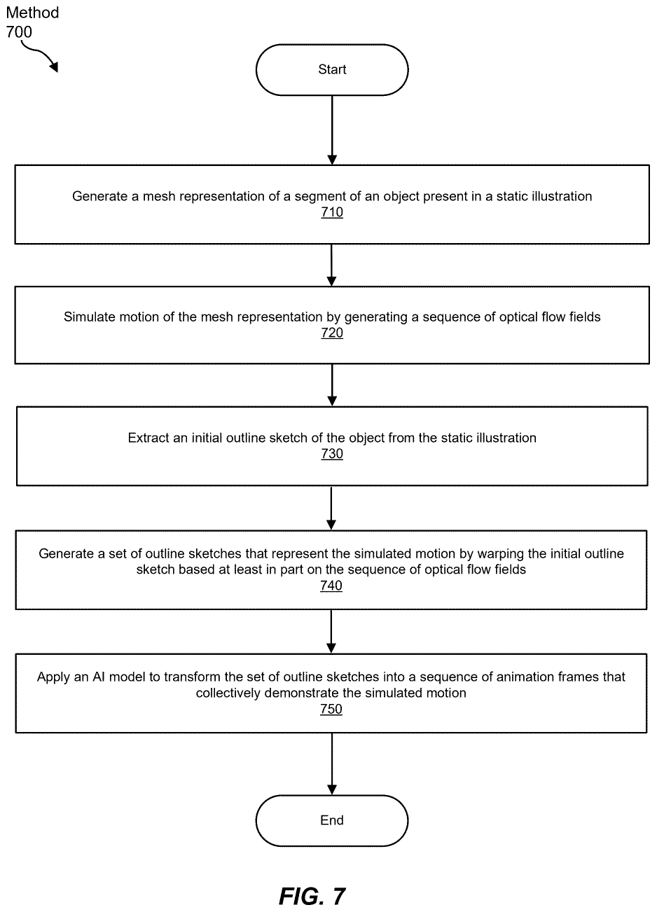

The following will provide, with reference to FIGS. 1-6 and 8-10, detailed descriptions of exemplary devices, systems, and corresponding implementations or configurations that facilitate and/or support developing generative animation via AI. The following will also provide, with reference to FIG. 7, examples of methods for developing generative animation via AI.

FIG. 1 illustrates an exemplary system 100 for developing generative animation via AI. In some examples, system 100 includes and/or represents circuitry 104 and/or a storage device 106. In one example, circuitry 104 and storage device 106 interface with and/or are communicatively coupled to one another. In this example, system 100 can implement, provide, and/or constitute part of an animation development platform and/or a digital platform like a streaming media service.

In some examples, storage device 106 stores, maintains, and manages a static illustration 108 of one or more objects. Static illustration 108 can include and/or represent a single, non-animated image, drawing, or frame that visually represents one or more objects, characters, or scenes. For example, unlike an animation, static illustration 108 can exclude and/or omit any motion and/or frame sequence. In one example, circuitry 104 accesses, obtains, and/or receives static illustration 108 and then analyses static illustration 108 to separate different segments of an object from one another. In this example, circuitry 104 creates and/or generates a mesh representation 112 of the segment of the object. In certain implementations, mesh representation 112 is two-dimensional.

In some examples, mesh representation 112 includes and/or represents a digital model of the segment of the object constructed as a network of interconnected vertices and edges that form triangles (e.g., two-dimensional triangles). In one example, mesh representation 112 serves as a geometric framework that approximates the shape and structure of the object in two dimensions. In this example, mesh representation 112 enables the application of physics-based simulation to realistically model and animate the motion and deformation of the object in response to external forces and/or user input.

In some examples, circuitry 104 simulates motion of mesh representation 112 by generating a sequence of optical flow fields 114. The sequence of optical flow fields 114 can include and/or represent an ordered series of data that captures and/or defines the direction and magnitude of motion for every part of an image and/or drawing between two consecutive frames. For example, the sequence of optical flow fields 114 can constitute and/or provide detailed instructions on how an outline of an object and/or corresponding features should be warped or transformed from one frame to another to create smooth, realistic, stylized animation from static illustration 108.

In some examples, the sequence of optical flow fields 114 describes and/or represents the dynamic behavior of the corresponding segment over time. In one example, circuitry 104 extracts and/or derives an initial outline sketch 116 of the object from static illustration 108. Initial outline sketch 116 can include and/or represent a simplified, monochromatic, texture-agnostic depiction of the object extracted from static illustration 108. For example, initial outline sketch 116 can depict only the essential contours, edges, and/or boundaries of the object without any color, shading, and/or surface detail present in static illustration 108. In one example, circuitry 104 can extract initial outline sketch 116 from static illustration 108 such that initial outline sketch 116 is void of color and texture present in static illustration 108. In this example, circuitry 104 generates the set of outline sketches 116 as a texture-agnostic video sequence devoid of the color and texture present in static illustration 108.

In some examples, circuitry 104 creates and/or generates a set of outline sketches 118 that represent the simulated motion by warping and/or deforming initial outline sketch 116 based at least in part on the sequence of optical flow fields 114. This warping and/or deformation process can involve shifting and/or moving the position of various points and/or lines in initial outline sketch 116 according to motion vectors specified by optical flow fields 114.

In some examples, circuitry 104 applies a Gaussian blur to the set of outline sketches 118 to address any segmentation inaccuracies. In one example, such segmentation inaccuracies can include and/or represent errors or imperfections that occur when identifying and/or separating segments of an object from one another or from the background of static illustration 108. In this example, such segmentation inaccuracies can result in incomplete, imprecise, and/or incorrect boundaries around the object, thereby causing parts of the object to be missed or excluded and/or leading to a jagged or fragmented outline of the object. The application of the Gaussian blur can improve the quality and/or consistency of the generative rendering in view of such segmentation inaccuracies.

In some examples, circuitry 104 applies an AI model 120 to transform the set of outline sketches 118 into a sequence of animation frames that collectively demonstrate the simulated motion. Such animation frames can be colorized, black and white, greyscale, etc. Such animation frames can also incorporate and/or represent restylings or embellishments of static illustration 108. The sequence of animation frames can preserve both the physical plausibility and/or the artistic style of static illustration 108.

In some examples, circuitry 104 can provide the sequence of animation frames as part of a content title available for streaming to viewers via a media streaming platform. In one example, AI model 120 is trained on a sample set of anime data, and the sequence of animation frames generated by circuitry 104 is characterized by an anime style of animation. For example, circuitry 104 can access and/or obtain the sample set of anime data from a database and then train AI model 120 based on the sample set of anime data.

In some examples, circuitry 104 interpolates one or more additional frames based at least in part on the sequence of animation frames. For example, circuitry 104 applies a cartoon interpolation model to introduce certain cartoonish features into the animation frames. Additionally or alternatively, the cartoon interpolation model can interpolate additional frames exhibiting non-physical dynamics that do not follow physical laws and/or expressive dynamics that show exaggerated motion in the sequence of animation frames. In such examples, circuitry 104 places each additional frame between the two appropriate animation frames to enhance the fluidity and smoothness of the animation.

In some examples, storage device 106 includes and/or represents any type or form of volatile or non-volatile storage device or medium capable of storing data and/or computer-readable instructions. In one example, storage device 106 maintains and/or stores one or more computer-readable instructions, modules, programs, and/or applications. Examples of storage device 106 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable memory. Although illustrated as a single unit in FIG. 1, storage device 106 can alternatively include and/or represent a collection of multiple storage devices capable of storing and/or maintaining data used in developing generative animation via AI.

In some examples, circuitry 104 includes and/or represents one or more electrical and/or electronic circuits capable of processing, applying, modifying, transforming, simulating, generating, displaying, transmitting, receiving, and/or executing data for system 100. In one example, circuitry 104 accesses and/or analyzes data stored in storage device 106 to facilitate and/or support generative animation via AI. Additionally or alternatively, circuitry 104 launches, performs, and/or executes certain executable files, code snippets, and/or computer-readable instructions to facilitate and/or support generative animation via AI.

Although illustrated as a single unit in FIG. 1, circuitry 104 can include and/or represent a collection of multiple processing units and/or electrical or electronic components that work and/or operate in conjunction with one another. Examples of circuitry 104 include, without limitation, processing devices, hardware processors, microprocessors, microcontrollers, field-programmable gate arrays (FPGAs), application-specific integrated circuits (ASICs), graphics processing units (GPUs), central processing units (CPUs), systems on chips (SoCs), parallel accelerated processors, tensor cores, integrated circuits, chiplets, receivers, transmitters, transceivers, storage devices, memory devices, digital logic, analog circuitry, digital circuitry, portions of one or more of the same, variations or combinations of one or more of the same, and/or any other suitable circuitry. In certain implementations, circuitry 104 can be distributed across multiple devices (e.g., servers, computing devices, etc.).

In some examples, system 100 can include and/or represent a computing device operated by a user. In other examples, system 100 can include and/or represent a server and a computing device communicatively coupled to one another via a network.

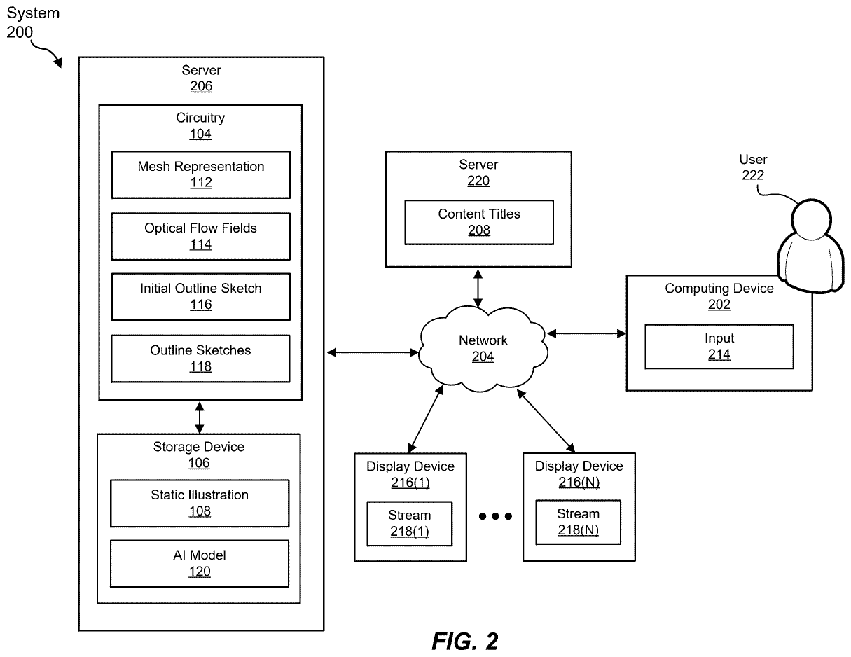

FIG. 2 illustrates an exemplary system 200 that facilitates and/or supports generative animation via AI. In some examples, system 200 in FIG. 2 includes and/or involves certain devices, components, configurations, and/or features that perform and/or provide functionalities that are similar and/or identical to those described above in connection with FIG. 1. In one example, system 200 includes and/or represents a server 206, a server 220, a computing device 202, and/or display devices 216(1)-(N). In this example, server 206, server 220, computing devices 202, and/or display devices 216(1)-(N) can communicate with one another via a network 204.

In some examples, a media streaming platform can include and/or represent server 220 and/or portions of network 204, among other devices that are not necessarily illustrated in FIG. 2. In this example, server 220 can store and/or provide content titles 208 for streaming to display devices 216(1)-(N) via network 204. For example, the media streaming platform can stream, transmit, and/or provide one or more of content titles 208 to display devices 216(1)-(N) via streams 218(1)-(N). In certain implementations, display devices 216(1)-(N) can correspond to different viewers watching streams 218(1)-(N), respectively.

In some examples, computing devices 202 can support and/or facilitate entry of input 214 by a user 222. In such examples, circuitry 104 receives and/or obtains input 214 indicating and/or defining one or more external forces to be applied to mesh representation 112. For example, input 214 can include and/or indicate a user-defined energy stroke representing a gust of wind (e.g., strength and/or direction) and/or a selection of gravity to simulate downward motion. In one example, user 222 can enter input 214 into computing device 202, which either analyzes input 214 itself or provides input 214 to server 206 via network 204 for analysis. Examples of the external forces include, without limitation, wind, gravity, and/or energy strokes, combinations or variations of one or more of the same, and/or any other suitable external forces.

In some examples, circuitry 104 simulates the motion of mesh representation 112 by applying, to mesh representation 112, a model of deformable body dynamics that accounts for input 214 and then generating the sequence of optical flow fields 114 based at least in part on an output of the model of deformable body dynamics. In one example, input 214 further indicates one or more rigging points of the object, which serve as anchors and/or constraints for certain features of mesh representation 112. For example, a rigging point can constitute and/or represent a fixed attachment point for a flag or an anchor for a character's limb.

In some examples, circuitry 104 analyzes static illustration 108 to separate multiple segments (e.g., hair, arms, legs, etc.) of the object (e.g., a person) relative to one another. For example, if static illustration 108 depicts a person, circuitry 104 can identify and/or segment the person's hair, left arm, right arm, and legs as individual segments. In one example, circuitry 104 creates and/or generates a two-dimensional triangulated mesh of a first segment (e.g., the person's left arm) from the multiple segments. In this example, circuitry 104 also creates and/or generates a two-dimensional triangulated mesh of a second segment (e.g., the person's right arm) from the multiple segments. In certain implementations, this approach enables independent simulation and/or animation of each segment, which facilitates and/or supports more realistic and/or flexible motion in the resulting animation frames.

In some examples, circuitry 104 simulates motion of the two-dimensional triangulated mesh of the first segment by generating a first sequence of optical flow fields. In such examples, the first sequence of optical flow fields describes and/or represents the dynamic behavior of the first segment over time. In one example, circuitry 104 creates and/or generates a first set of outline sketches that represent the simulated motion of the first segment's two-dimensional triangulated mesh by warping initial outline sketch 116 based at least in part on the first sequence of optical flow fields. In this example, circuitry 104 applies AI model 120 to transform the first set of outline sketches into a first sequence of colorized animation frames that collectively demonstrate the simulated motion of the first segment's two-dimensional triangulated mesh. In certain implementations, the first sequence of colorized animation frames also incorporate and/or represent additional restylings and/or embellishments of static illustration 108 beyond colorization.

In some examples, circuitry 104 simulates motion of the two-dimensional triangulated mesh of the second segment by generating a second sequence of optical flow fields. In such examples, the second sequence of optical flow fields describes and/or represents the dynamic behavior of the second segment over time. In one example, circuitry 104 creates and/or generates a second set of outline sketches that represent the simulated motion of the second segment's two-dimensional triangulated mesh by warping initial outline sketch 116 based at least in part on the second sequence of optical flow fields. In this example, circuitry 104 applies AI model 120 to transform the second set of outline sketches into a second sequence of colorized animation frames that collectively demonstrate the simulated motion of the second segment's two-dimensional triangulated mesh. In certain implementations, the second sequence of colorized animation frames also incorporate and/or represent additional restylings and/or embellishments of static illustration 108 beyond colorization.

In some examples, upon generating the first and second sequences of colorized animation frames, circuitry 104 combines and/or integrates these animation frames, which correspond to the different segments, into a unified sequence that depicts a complete representation of the animated object. For example, circuitry 104 can overlay, composite, and/or merge these sequences according to the spatial relationships of the segments within static illustration 108. In this example, circuitry 104 synchronizes the motion and/or appearance of each segment so that the combined animation frames accurately represent the coordinated movement of the entire object.

In some examples, circuitry 104 uses compositing techniques to layer the animation frames for each segment. By doing so, circuitry 104 can ensure that overlapping regions are rendered correctly and/or that the final animation maintains visual consistency and stylistic fidelity. In one example, the integrated sequence of animation frames can then be presented as a single, cohesive animation that shows all segments moving together in accordance with the simulated motion and user input. In certain implementations, circuitry 104 provides the final animation frames to server 220 for entry into content titles 208 available for streaming to viewers via the media streaming platform.

In some examples, circuitry 104 applies a cartoon interpolation model to introduce non-physical dynamics that do not follow physical laws in the sequence of animation frames and/or expressive dynamics that show exaggerated motion in the sequence of animation frames. In one example, the cartoon interpolation model generates one or more intermediate frames between existing animation frames to enhance the fluidity and smoothness of the animation. For example, the cartoon interpolation model can introduce exaggerated stretching, squashing, and/or rapid motion transitions to convey emotion, energy, and/or stylistic effects. Additionally, the cartoon interpolation model can introduce expressive dynamics, such as accentuated motion arcs, dramatic pauses, or stylized deformations, further increasing the visual appeal and/or artistic expressiveness of the animation.

In some examples, circuitry 104 applies a Gaussian blur to the set of outline sketches 118 prior to generative rendering. The Gaussian blur can constitute and/or represent a digital image processing technique that smooths and/or softens an image by reducing sharp edges and/or detail. For example, a Gaussian blur can involve applying a Gaussian mathematical function to each pixel in the image. In this example, the Gaussian function averages the pixel's value with the values of the pixel's neighbors. In certain implementations, the Gaussian function gives more weight to pixels positioned closer to the center of the image.

In some examples, the Gaussian blur smooths out segmentation boundaries and/or reduces artifacts caused by imperfect object separation, thereby improving the quality, coherence, and/or consistency of the resulting animation frames produced by AI model 120. Additionally or alternatively, circuitry 104 extracts initial outline sketch 116 from static illustration 108 such that initial outline sketch 116 is void of color and/or texture present in static illustration 108. In one example, circuitry 104 generates the set of outline sketches 118 as a texture-agnostic video sequence devoid of the color and texture present in static illustration 108.

In some examples, circuitry 104 extracts initial outline sketch 116 from static illustration 108 by isolating the geometric contours and/or boundaries of the object while omitting any color, shading, and/or texture information present in static illustration 108. In one example, this extraction process produces a monochromatic, texture-agnostic outline sketch that serves as a robust basis for subsequent motion simulation and/or warping. In this example, circuitry 104 generates the set of outline sketches 118 as a texture-agnostic video sequence such that each outline sketch in the sequence represents the dynamic motion of the object's outline without incorporating color or texture from static illustration 108.

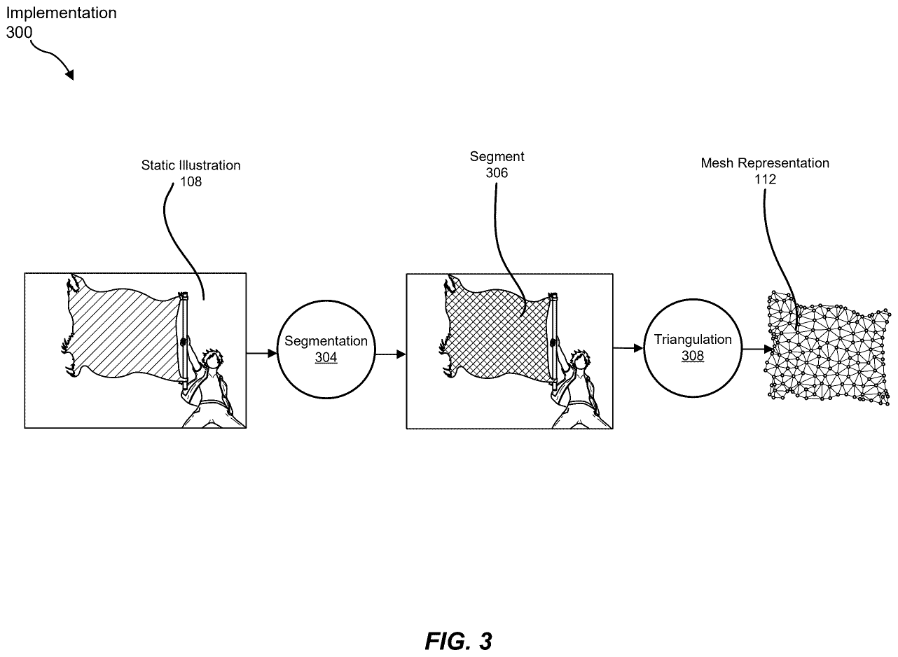

FIG. 3 illustrates an exemplary implementation 300 of at least one phase of a process for developing generative animation via AI. In some examples, implementation 300 in FIG. 3 includes and/or involves one or more processes, tasks, and/or operations that are similar and/or identical to those described above in connection with FIG. 1 and/or FIG. 2. In one example, implementation 300 can be performed by any of the devices, components, and/or systems described in FIG. 1 and/or FIG. 2.

In some examples, implementation 300 includes and/or involves analyzing static illustration 108 to identify and/or segment an object of interest. For example, circuitry 104 performs a segmentation 304 of static illustration 108 to identify and/or separate a flag represented in static illustration 108. In this example, segmentation 304 involves applying image analysis algorithms—such as edge detection, region growing, and/or machine learning-based segmentation models—to static illustration 108 in order to accurately delineate the boundaries of the flag represented in static illustration 108. In certain implementations, circuitry 104 can apply input 214—such as selection points and/or strokes—to guide the segmentation process and/or to improve the precision of object separation. For example, segmentation 304 enables circuitry 104 to isolate the flag represented in static illustration 108 from the background and/or other segments and/or objects, thereby resulting in a clearly defined segment 306 capable of being further processed.

In some examples, implementation 300 includes and/or involves generating mesh representation 112 of segment 306 via a triangulation 308. In one example, triangulation 308 involves subdividing segment 306 into a network of interconnected triangles. For example, circuitry 104 can employ algorithms like Delaunay and/or constrained triangulation to segment 306. In this example, triangulation 308 can ensure that mesh representation 112 accurately conforms to the contours and/or geometry of segment 306. In certain embodiments, mesh representation 112 provides a simulation-ready structure that supports subsequent physics-based motion modeling. In such embodiments, the simulation-ready structure enables realistic deformation and/or animation of segment 306 in response to external forces and/or user input.

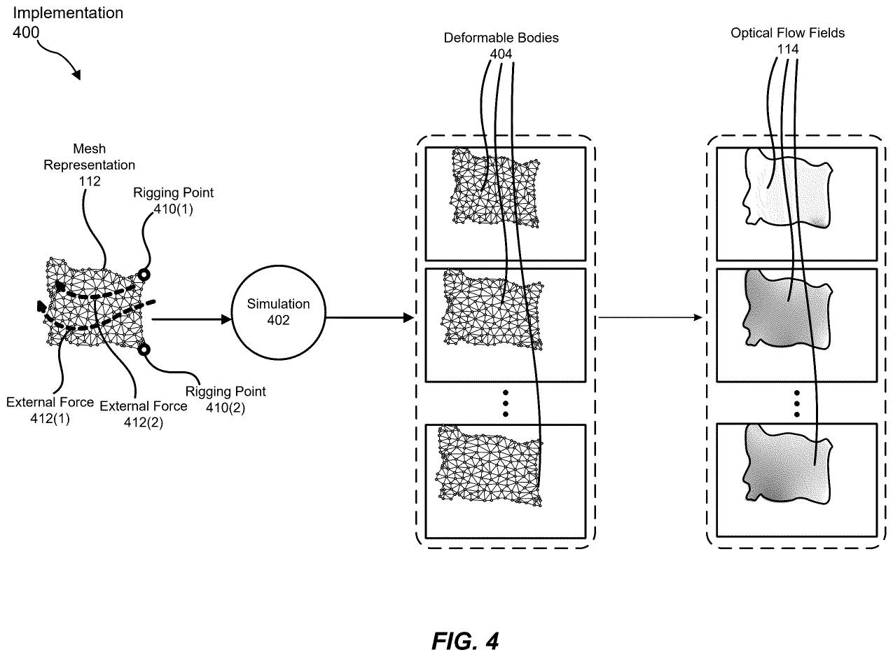

FIG. 4 illustrates an exemplary implementation 400 of at least one phase of a process for developing generative animation via AI. In some examples, implementation 400 in FIG. 4 includes and/or involves one or more processes, tasks, and/or operations that are similar and/or identical to those described above in connection with any of FIGS. 1-3. In one example, implementation 400 can be performed by any of the devices, components, and/or systems described in FIGS. 1-3.

In some examples, implementation 400 includes and/or involves applying rigging points 410(1)-(2) to mesh representation 112. In one example, circuitry 104 can designate rigging points 410(1)-(2) as specific vertices or locations on mesh representation 112. In this example, rigging points 410(1)-(2) serve as anchors, constraints, or attachment points for mesh representation 112. For example, as mesh representation 112 models a flag, circuitry 104 can assign and/or place rigging points 410(1)-(2) at different corners of the flag attached to a pole. In this example, rigging points 410(1)-(2) ensures that those corner regions remain fixed during simulation. In certain embodiments, rigging points 410(1)-410(2) enable precise control over the motion and/or deformation of mesh representation 112 by allowing users to define which regions should remain stationary, follow a trajectory, and/or respond to external forces.

In some examples, implementation 400 includes and/or involves applying external forces 412(1)-412(N) to mesh representation 112. In one example, circuitry 104 can receive input 214 specifying the magnitude, direction, and/or type of external forces 412(1)-412(N). For example, input 214 can indicate and/or define wind, gravity, and/or user-defined energy strokes. As a specific example, circuitry 104 can apply external force 412(1) to simulate wind blowing across the surface of the flag, thereby causing mesh representation 112 to deform and/or move in a physically plausible way. Additionally or alternatively, circuitry 104 can also apply multiple external forces 412(1)-412(N) simultaneously and/or in sequence to achieve complex motion effects. By combining rigging points 410(1)-410(2) and external forces 412(1)-412(N), implementation 400 can enable highly customizable and/or realistic animation of mesh representation 112 reflecting both user intent and physical dynamics.

In some examples, implementation 400 includes and/or involves performing a simulation 402 on mesh representation 112. For example, circuitry 104 can execute and/or implement simulation 402 by applying the designated rigging points 410(1)-410(2) and/or external forces 412(1)-412(N) to mesh representation 112. During simulation 402, circuitry 104 utilizes a model of deformable body dynamics to compute how mesh representation 112 deforms and/or moves over time in response to the applied constraints and forces.

In some examples, simulation 402 involves calculating the resulting displacement of each vertex in mesh representation 112 and/or generating a sequence of optical flow fields 114 that describe the motion of mesh representation 112 at each time step. In one example, simulation 402 involves modeling mesh representation 112 as one or more deformable bodies 404. For example, circuitry 104 applies the principles of deformable body dynamics to mesh representation 112 to treat mesh representation 112 as deformable bodies 404 that can bend, stretch, compress, and/or otherwise change shape in response to rigging points 410(1)-410(2) and external forces 412(1)-412(N).

In some examples, during simulation 402, circuitry 104 calculates the internal and/or external forces acting on deformable bodies 404, including the effects of user-defined constraints and/or environmental influences like wind or gravity. As simulation 402 progresses, circuitry 104 determines the resulting deformation and/or motion of deformable bodies 404 over time. In one example, simulation 402 also involves generating a sequence of optical flow fields 114 to describe the motion of mesh representation 112 at each time step. In certain embodiments, optical flow fields 114 capture the dynamic, physically plausible motion (e.g., fluttering, waving, stretching, etc.) of the object as simulated by deformable bodies 404. In such embodiments, optical flow fields 114 provide essential motion data for subsequent animation steps like warping outline sketches and/or synthesizing colorized animation frames.

In some examples, circuitry 104 performs simulation 402 in part by applying a deformation map equation represented as: φᵢ(X)=EᵢX+bᵢ. This equation defines a deformation map for the i-th triangle in a two-dimensional mesh. In the deformation map equation, X is the position in the undeformed and/or rest state, Eᵢ is a matrix representing the local deformation (e.g., scaling, rotation, shearing, etc.), and/or bᵢ is a translation vector. In certain embodiments, the deformation map describes how each triangle in the two-dimensional mesh moves and/or deforms over time.

Additionally or alternatively, circuitry 104 performs simulation 402 in part by applying an internal resisting force equation represented as:

$$f ( x ) = \frac{\partial x ( x )}{\partial x} .$$

This equation defines the internal force acting on the mesh as the negative gradient of the potential energy with respect to the vertex positions. In this example, the force represented by this equation resists deformation and tries to restore the mesh to its rest shape.

In some examples, circuitry 104 performs simulation 402 in part by applying a total potential energy equation represented as:

$$E ( x ) = {\sum }_{i = 1}^{N} w ( {E}_{i} ) {V}_{i} .$$

This equation defines the total potential energy of the deformable body (e.g., the mesh). In the total potential energy equation, w(Eᵢ) is the energy density function for the i-th triangle (e.g., measuring strain or defamation), Vᵢ is the volume or area (e.g., in two dimensions) of the triangle. In certain embodiments, the sum is computed over all triangles in the mesh.

In some examples, circuitry 104 performs simulation 402 in part by applying a total potential energy equation represented as:

$$\frac{{d}^{2} x}{d {t}^{2}} = x {f}^{- 1} ( f ( x ) + f ( x ) ) .$$

This equation expresses Newton's second law for the deformable mesh. In particular, this equation relates the acceleration of the mesh vertices to the sum of internal and external forces.

In some examples, circuitry 104 performs simulation 402 in part by applying the fixed corotated energy density equation represented as:

$$W ( F ) = A ( F - R ) ( R + \frac{λ}{2} {( det det ( R ) - 1 )}^{2} ) .$$

This equation defines the energy density function for the fixed corotated constitutive model used to model the elastic behavior of the mesh. In this equation, F is the deformable gradient, R is the rotational part of F (from polar decomposition), and 1 is a material parameter. This energy density function penalizes both stretching and compression and changes in volume, capturing the physical properties of the simulated material.

In some examples, circuitry 104 performs simulation 402 in part by applying a sketch warping equation represented as: Sₜ=W(S₀F₀₋ₜ, ω_{0→t}). This equation describes how to generate the outline sketch at time Sₜ by warping the initial outline sketch S₀ using the optical flow field F₀₋ₜ and warping weights ω_{0→t}. In this equation, the warping operator W applies the motion information to the sketch, producing a dynamic sequence of outline sketches that reflect the simulated motion.

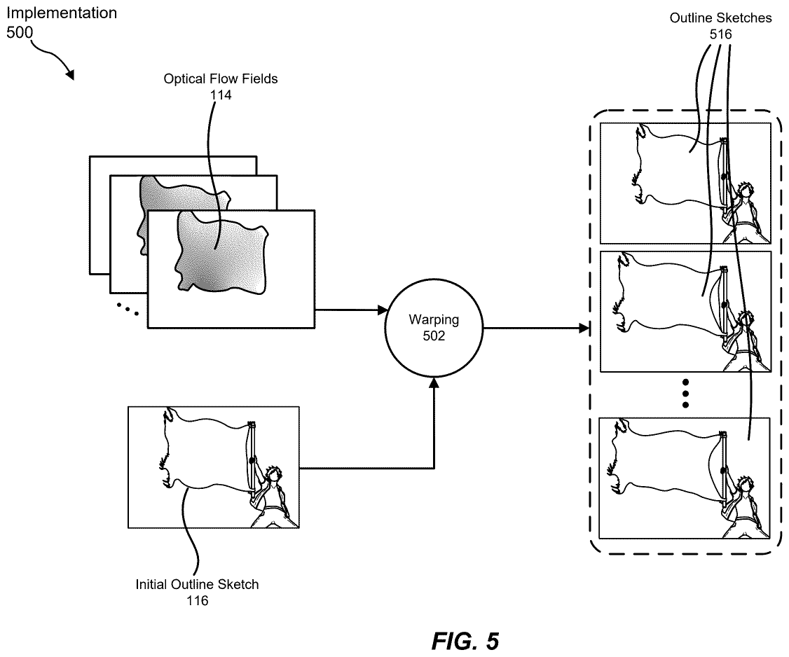

FIG. 5 illustrates an exemplary implementation 500 of at least one phase of a process for developing generative animation via AI. In some examples, implementation 500 in FIG. 5 includes and/or involves one or more processes, tasks, and/or operations that are similar and/or identical to those described above in connection with any of FIGS. 1-4. In one example, implementation 500 can be performed by any of the devices, components, and/or systems described in FIGS. 1-4.

In some examples, implementation 500 includes and/or involves applying a warping 502 to optical flow fields 114 to produce outline sketches 516 of the object. For example, circuitry 104 applies warping 502 by using the optical flow fields 114 generated from the simulation of mesh representation 112 to deform and/or transform initial outline sketch 116 over a sequence of time steps. Through warping 502, circuitry 104 generates and/or outputs a set of outline sketches 516 that each represent the object's outline at a different moment in the simulated motion. In this example, warping 502 takes in optical flow fields 114 and initial outline sketch 116 as inputs and provides outline sketches 516 as outputs. In certain embodiments, outline sketches 516 collectively form a texture-agnostic video sequence that captures the dynamic motion of the object. In such embodiments, outline sketches 516 provide a robust geometric foundation for subsequent colorization and/or rendering steps in the generative animation pipeline.

In some examples, circuitry 104 performs warping 502 at least in part by applying a sketch warping equation represented as: Sₜ=W(S₀F₀₋ₜ, ω_{0→t}). This equation describes how to generate the outline sketch at time Sₜ by warping the initial outline sketch S₀ using the optical flow field F₀₋ₜ and warping weights ω_{0→t}. In this equation, the warping operator W applies the motion information to the outline sketch. This equation enables circuitry 104 to produce a dynamic sequence of outline sketches that reflect the simulated motion.

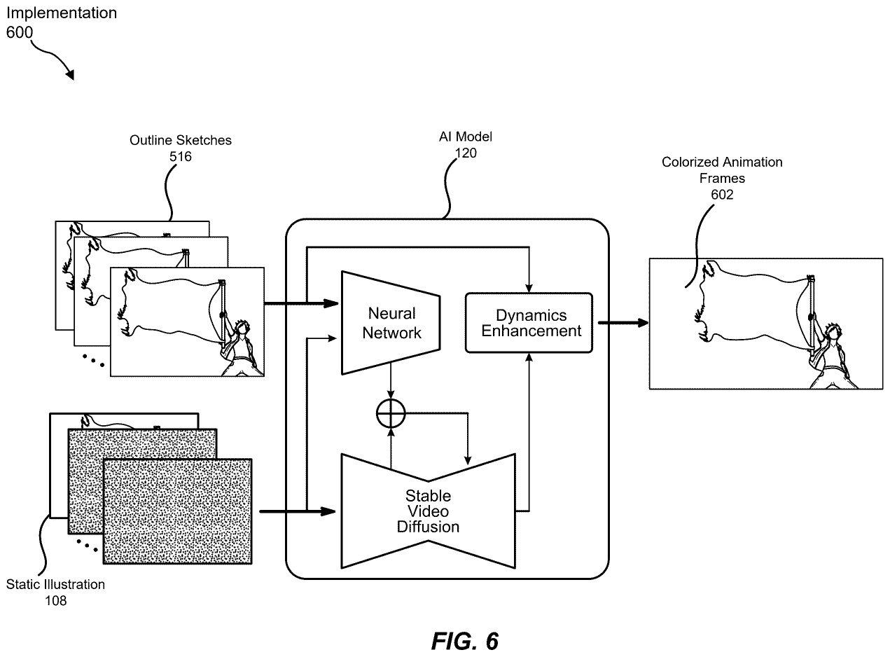

FIG. 6 illustrates an exemplary implementation 600 of at least one phase of a process for developing generative animation via artificial intelligence. In some examples, implementation 600 in FIG. 6 includes and/or involves one or more processes, tasks, and/or operations that are similar and/or identical to those described above in connection with any of FIGS. 1-5. In one example, implementation 600 can be performed by any of the devices, components, and/or systems described in FIGS. 1-5.

In some examples, implementation 600 includes and/or involves applying AI model 120 to outline sketches 516 and static illustration 108 to generate colorized animation frames 602. For example, circuitry 104 provides outline sketches 516 representing the dynamic, texture-agnostic motion of the object and static illustration 108 serving as a style and color reference as inputs to AI model 120. In this example, AI model 120 implements a neural network, a stable video diffusion feature, and/or a dynamics enhancement feature to transform outline sketches 516 into colorized animation frames 602 with reference to static illustration 108.

In some examples, the neural network guides the generative process using geometric information from outline sketches 516. In one example, the neural network is designed to inject external control information into the generative process. In this example, the neural network receives outline sketches 516 as its primary control input. In certain embodiments, the neural network processes outline sketches 516 to extract geometric and/or motion cues. In such embodiments, the neural network encodes the geometric and/or motion cues as feature maps, which are provided to the stable video diffusion feature to ensure that the generated animation frames adhere closely to the structure and/or motion indicated by outline sketches 516.

In some examples, the stable video diffusion feature synthesizes temporally consistent, high-quality animation frames. In one example, the stable video diffusion feature operates in a latent space and uses a diffusion process to iteratively refine noisy latent representations into coherent video frames. In this example, the stable video diffusion feature receives both the encoded control signals from the neural network and static illustration 108 as a style and/or color reference. By conditioning the diffusion process on the neural network's output, the stable video diffusion feature can generate animation frames that not only follow the desired motion but also preserve the artistic style, color palette, and/or visual fidelity of static illustration 108.

In some examples, the stable video diffusion feature applies a latent diffusion process represented as: z=\sqrt{aₖ}z₀+\sqrt{1−aₖ}∈, ∈˜N(0, F). In this latent diffusion process, the latent code z₀ is gradually perturbed by adding Gaussian noise ∈ at each step k. The parameter aₖ controls the amount of noise added at each step. In certain embodiments, the latent diffusion process is used to train AI model 120 to learn how to denoise and reconstruct the original data from noisy versions of the same.

In some examples, the stable video diffusion feature applies a denoising objective represented as:

$${I}_{- 1} = {‖ ξ - {ε}_{0} ( {z}_{2} ; c , t ) ‖}_{2}^{2} .$$

This denoising objective defines and/or represents the loss function used to train the denoising model for the stable video diffusion feature. In the denoising objective, the model ε₀ is trained to predict the original latent code ξ from the noisy input z₂ conditioned on additional information c (such as control signals or sketches) and the time step t. The loss is the squared L2 norm between the prediction and the ground truth.

In some examples, the dynamics enhancement feature refines the animation by introducing expressive or non-physical motion effects in accordance with input 214. In this example, the dynamics enhancement feature introduces expressive and/or non-physical motion effects like exaggerated deformations, stylized timing, and/or cartoon-like dynamics in accordance with user input 214 and/or predefined animation parameters. In certain embodiments, the dynamics enhancement feature operates by post-processing the generated frames or by providing additional conditioning signals during the diffusion process.

In some examples, AI model 120 outputs a sequence of colorized animation frames 602 that collectively demonstrate the simulated motion of the object while preserving the artistic style and/or visual fidelity of static illustration 108. In one example, colorized animation frames 602 are suitable for integration into content titles 208 and/or for presentation to viewers via a media streaming platform.

In some embodiments, the training of AI model 120 involves a multi-stage process. In one example, the neural network is trained to map outline sketches 516 to geometric features using a dataset of paired sketches and/or animation sequences. In this example, the stable video diffusion module is trained on a large corpus of anime-style video data with the neural network's outputs and corresponding static illustrations as conditioning inputs. The dynamics enhancement is trained and/or fine-tuned using curated samples of expressive or non-physical animation. This training and/or fine-tuning can enable the dynamics enhancement feature to learn certain stylistic effects. Through this integrated architecture, AI model 120 is able to generate a sequence of colorized animation frames 602 that collectively demonstrate the simulated motion of the object, maintain temporal consistency, and/or preserve the artistic style of static illustration 108 while also supporting advanced non-physical and/or expressive dynamics.

In some examples, the various systems, components, and/or features described in connection with FIGS. 1-2 can include and/or represent one or more additional circuits, components, and/or features that are not necessarily illustrated and/or labeled in FIGS. 1-2. For example, the systems, components, and/or features illustrated in FIGS. 1-2 can also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, network devices, networks, combinations or variations of one or more of the same, and/or any other suitable components. In certain implementations, one or more of these additional circuits, components, and/or features can be inserted and/or applied between any of the existing circuits, components, and/or features illustrated in FIGS. 1-2 consistent with the aims and/or objectives described herein. Accordingly, the couplings and/or connections described with reference to FIGS. 1-2 can be direct connections with no intermediate components, devices, and/or nodes or indirect connections with one or more intermediate components, devices, and/or nodes.

In some examples, the phrase “to couple” and/or the term “coupling”, as used herein, can refer to a direct connection and/or an indirect connection. For example, a direct coupling between two components can constitute and/or represent a coupling in which those two components are directly connected to each other by a single node that provides continuity from one of those two components to the other. In other words, the direct coupling can exclude and/or omit any additional components between those two components.

Additionally or alternatively, an indirect coupling between two components can constitute and/or represent a coupling in which those two components are indirectly connected to each other by multiple nodes that fail to provide continuity from one of those two components to the other. In other words, the indirect coupling can include and/or incorporate at least one additional component between those two components. In one example, the indirect coupling can include and/or incorporate at least one additional computing device between two computing devices illustrated in any of FIGS. 1-2. In some implementations, one or more components and/or devices illustrated in FIGS. 1-2 can be omitted and/or excluded from the corresponding systems.

FIG. 7 is a flow diagram of an exemplary computer-implemented method 700 for developing generative animation via AI. In one example, the steps shown in FIG. 7 are performed by circuitry incorporated and/or implemented in one or more systems and/or computing devices. Additionally or alternatively, the steps shown in FIG. 7 incorporate and/or involve certain sub-steps and/or variations consistent with the descriptions provided above in connection with FIGS. 1-6.

As illustrated in FIG. 7, method 700 includes and/or involves the step of generating a mesh representation of a segment of an object present in a static illustration (710). Step 710 is performed in a variety of ways, including any of those described above in connection with FIGS. 1-6. For example, circuitry can generate a mesh representation of a segment of an object present in a static illustration.

Method 700 also includes and/or involves the step of simulating motion of the mesh representation by generating a sequence of optical flow fields (720). Step 720 is performed in a variety of ways, including any of those described above in connection with FIGS. 1-6. For example, the circuitry can simulate motion of the mesh representation by generating a sequence of optical flow fields.

Method 700 further includes and/or involves the step of extracting an initial outline sketch of the object from the static illustration (730). Step 730 is performed in a variety of ways, including any of those described above in connection with FIGS. 1-6. For example, the circuitry can extract an initial outline sketch of the object from the static illustration.

Method 700 further includes and/or involves the step of generating a set of outline sketches that represent the simulated motion by warping the initial outline sketch based at least in part on the sequence of optical flow fields (740). Step 740 is performed in a variety of ways, including any of those described above in connection with FIGS. 1-6. For example, the circuitry can generate a set of outline sketches that represent the simulated motion by warping the initial outline sketch based at least in part on the sequence of optical flow fields.

Method 700 further includes and/or involves the step of applying an AI model to transform the set of outline sketches into a sequence of animation frames that collectively demonstrate the simulated motion (750). Step 750 is performed in a variety of ways, including any of those described above in connection with FIGS. 1-6. For example, the circuitry can apply an AI model to transform the set of outline sketches into a sequence of animation frames that collectively demonstrate the simulated motion.

Furthermore, a non-transitory computer-readable medium comprises one or more computer-executable instructions that, when executed by circuitry of at least one computing device, cause the computing device to (1) generate a mesh representation of a segment of an object present in a static illustration, (2) simulate motion of the mesh representation by generating a sequence of optical flow fields, (3) extract an initial outline sketch of the object from the static illustration, (4) generate a set of outline sketches that represent the simulated motion by warping the initial outline sketch based at least in part on the sequence of optical flow fields, and (5) apply an artificial intelligence (AI) model to transform the set of outline sketches into a sequence of animation frames that collectively demonstrate the simulated motion.

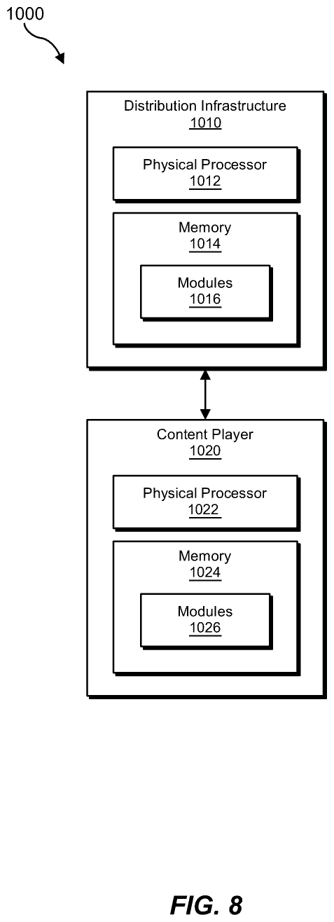

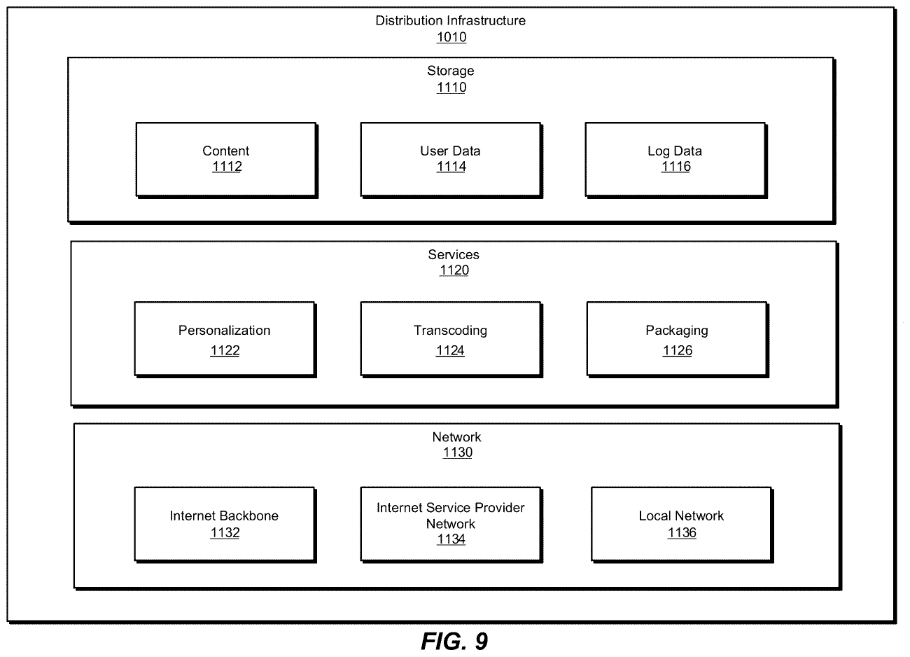

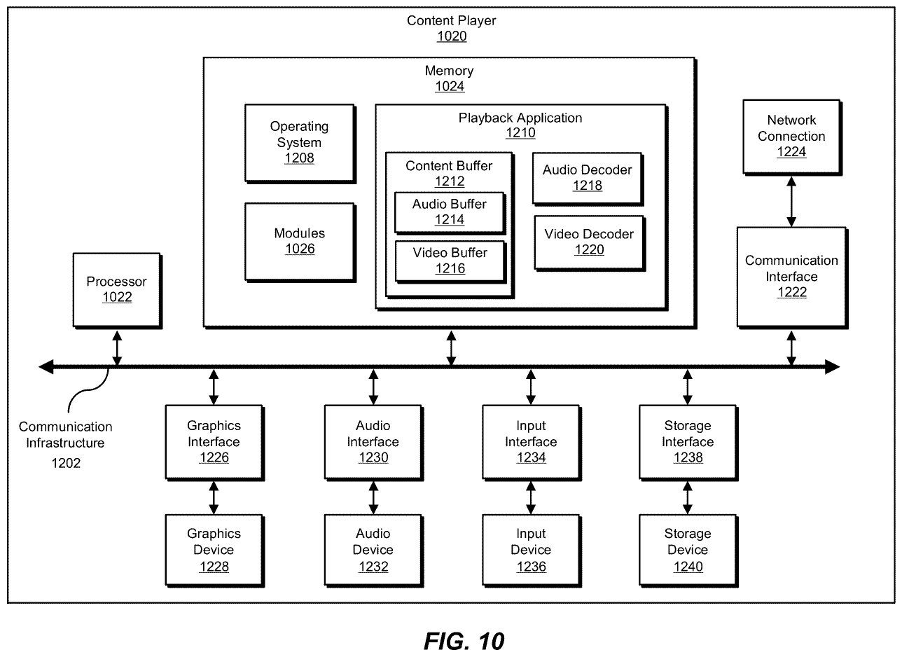

The following will provide, with reference to FIG. 8, detailed descriptions of exemplary ecosystems in which content is provisioned to end nodes and in which requests for content are steered to specific end nodes. The discussion corresponding to FIGS. 9 and 10 presents an overview of an exemplary distribution infrastructure and an exemplary content player used during playback sessions, respectively. These exemplary ecosystems and distribution infrastructures are implemented in any of the embodiments described above with reference to FIGS. 1-7.

FIG. 8 is a block diagram of a content distribution ecosystem 1000 that includes a distribution infrastructure 1010 in communication with a content player 1020. In some embodiments, distribution infrastructure 1010 is configured to encode data at a specific data rate and to transfer the encoded data to content player 1020. Content player 1020 is configured to receive the encoded data via distribution infrastructure 1010 and to decode the data for playback to a user. The data provided by distribution infrastructure 1010 includes, for example, audio, video, text, images, animations, interactive content, haptic data, virtual or augmented reality data, location data, gaming data, or any other type of data that is provided via streaming.

Distribution infrastructure 1010 generally represents any services, hardware, software, or other infrastructure components configured to deliver content to end users. For example, distribution infrastructure 1010 includes content aggregation systems, media transcoding and packaging services, network components, and/or a variety of other types of hardware and software. In some cases, distribution infrastructure 1010 is implemented as a highly complex distribution system, a single media server or device, or anything in between. In some examples, regardless of size or complexity, distribution infrastructure 1010 includes at least one physical processor 1012 and at least one memory 1014. One or more modules 1016 are stored or loaded into memory 1014 to enable adaptive streaming, as discussed herein.

Content player 1020 generally represents any type or form of device or system capable of playing audio and/or video content that has been provided over distribution infrastructure 1010. Examples of content player 1020 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1010, content player 1020 includes a physical processor 1022, memory 1024, and one or more modules 1026. Some or all of the adaptive streaming processes described herein is performed or enabled by modules 1026, and in some examples, modules 1016 of distribution infrastructure 1010 coordinate with modules 1026 of content player 1020 to provide adaptive streaming of multimedia content.

In certain embodiments, one or more of modules 1016 and/or 1026 in FIG. 8 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 8 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 1010 according to certain embodiments. Distribution infrastructure 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 can store a variety of different items including content 1112, user data 1114, and/or log data 1116. Content 1112 includes television shows, movies, video games, user-generated content, and/or any other suitable type or form of content. User data 1114 includes personally identifiable information (PII), payment information, preference settings, language and accessibility settings, and/or any other information associated with a particular user or content player. Log data 1116 includes viewing history information, network throughput information, and/or any other metrics associated with a user's connection to or interactions with distribution infrastructure 1010.

Services 1120 includes personalization services 1122, transcoding services 1124, and/or packaging services 1126. Personalization services 1122 personalize recommendations, content streams, and/or other aspects of a user's experience with distribution infrastructure 1010. Transcoding services 1124 compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 1130 includes an Internet backbone 1132, an internet service provider 1134, and/or a local network 1136. As discussed in greater detail below, bandwidth limitations and bottlenecks within one or more of these network segments triggers video and/or audio bit rate adjustments.

FIG. 10 is a block diagram of an exemplary implementation of content player 1020 of FIG. 8. Content player 1020 generally represents any type or form of computing device capable of reading computer-executable instructions. Content player 1020 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 1022 and memory 1024, content player 1020 includes a communication infrastructure 1202 and a communication interface 1222 coupled to a network connection 1224. Content player 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by processor 1022. In one example, operating system 1208 includes and/or represents software that manages computer hardware and software resources and/or provides common services to computer programs and/or applications on content player 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 includes, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In normal operation, playback application 1210 receives a request from a user to play a specific title or specific content. Playback application 1210 then identifies one or more encoded video and audio streams associated with the requested title. After playback application 1210 has located the encoded streams associated with the requested title, playback application 1210 downloads sequence header indices associated with each encoded stream associated with the requested title from distribution infrastructure 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file is then downloaded into content buffer 1212, which is configured to serve as a first-in, first-out queue. In one embodiment, each unit of downloaded data includes a unit of video data or a unit of audio data. As units of video data associated with the requested digital content file are downloaded to the content player 1020, the units of video data are pushed into the content buffer 1212. Similarly, as units of audio data associated with the requested digital content file are downloaded to the content player 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and outputs the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of distribution infrastructure 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with processor 1022. Alternatively, graphics interface 1226 is configured as a hardware accelerator that is distinct from (i.e., is not integrated within) a chipset that includes processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 10, content player 1020 also includes at least one input device 1236 coupled to communication infrastructure 1202 via input interface 1234. Input device 1236 generally represents any type or form of computing device capable of providing input, either computer or human generated, to content player 1020. Examples of input device 1236 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of content player 1020.

Many other devices or subsystems are included in or connected to content player 1020. Conversely, one or more of the components and devices illustrated in FIG. 8 need not be present to practice the embodiments described and/or illustrated herein. The devices and subsystems referenced above are also interconnected in different ways from that shown in FIG. 10. Content player 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium.

The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 1020. All or a portion of the computer program stored on the computer-readable medium is then stored in memory 1024 and/or storage device 1240. When executed by processor 1022, a computer program loaded into memory 1024 causes processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, content player 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) can each include at least one memory device and at least one physical processor.

In some examples, the term “memory device” generally refers to any type or form of volatile or non-volatile storage device or medium capable of storing data and/or computer-readable instructions. In one example, a memory device can store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor can access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein can represent portions of a single module or application. In addition, in certain embodiments one or more of these modules can represent one or more software applications or programs that, when executed by a computing device, can cause the computing device to perform one or more tasks. For example, one or more of the modules described and/or illustrated herein can represent modules stored and configured to run on one or more of the computing devices or systems described and/or illustrated herein. One or more of these modules can also represent all or portions of one or more special-purpose computers configured to perform one or more tasks.

In addition, one or more of the modules described herein can transform data, physical devices, and/or representations of physical devices from one form to another. Additionally or alternatively, one or more of the modules recited herein can transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein can be shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
one or more storage devices configured to store a static illustration of at least one object; and
circuitry configured to:
generate a mesh representation of a segment of the object in the static illustration;
simulate motion of the mesh representation by generating a sequence of optical flow fields;
extract an initial outline sketch of the object from the static illustration;
generate a set of outline sketches that represent the simulated motion by warping the initial outline sketch based at least in part on the sequence of optical flow fields; and
apply an artificial intelligence (AI) model to transform the set of outline sketches into a sequence of animation frames that collectively demonstrate the simulated motion.

2. The system of claim 1, wherein the circuitry is further configured to:
receive input indicating one or more external forces to be applied to the mesh representation; and
simulate the motion of the mesh representation by:
applying, to the mesh representation, a model of deformable body dynamics that accounts for the input; and
generating the sequence of optical flow fields based at least in part on an output of the model of deformable body dynamics.

3. The system of claim 2, wherein:
the input further indicates one or more rigging points of the object; and
the external forces comprise at least one of:
wind;
gravity; or
user-defined energy strokes.

4. The system of claim 1, wherein the circuitry is further configured to:
analyze the static illustration to separate a plurality of segments of the object relative to one another;
generate a first two-dimensional triangulated mesh representation of a first segment included in the plurality of segments; and
generate a second two-dimensional triangulated mesh representation of a second segment included in the plurality of segments.

5. The system of claim 4, wherein the circuitry is further configured to:
simulate motion of the first two-dimensional triangulated mesh representation by generating a first sequence of optical flow fields;
generate a first set of outline sketches that represent the simulated motion of the first two-dimensional triangulated mesh representation by warping the initial outline sketch based at least in part on the first sequence of optical flow fields; and
apply the AI model to transform the first set of outline sketches into a first sequence of animation frames that collectively demonstrate the simulated motion of the first two-dimensional triangulated mesh representation.

6. The system of claim 5, wherein the circuitry is further configured to:
simulate motion of the second two-dimensional triangulated mesh representation by generating a second sequence of optical flow fields;
generate a second set of outline sketches that represent the simulated motion of the second two-dimensional triangulated mesh representation by warping the initial outline sketch based at least in part on the second sequence of optical flow fields; and
apply the AI model to transform the second set of outline sketches into a second sequence of animation frames that collectively demonstrate the simulated motion of the second two-dimensional triangulated mesh representation.

7. The system of claim 1, wherein the circuitry is further configured to:
interpolate at least one additional frame based at least in part on the sequence of animation frames; and
place the additional frame between two frames included in the sequence of animation frames to enhance fluidity of animation.

8. The system of claim 7, wherein the circuitry is further configured to apply a cartoon interpolation model to introduce:
non-physical dynamics that do not follow physical laws in the sequence of animation frames; or
expressive dynamics that show exaggerated motion in the sequence of animation frames.

9. The system of claim 1, wherein the circuitry is further configured to apply a Gaussian blur to the set of outline sketches to address one or more segmentation inaccuracies.

10. The system of claim 1, wherein the circuitry is further configured to:
extract the initial outline sketch from the static illustration such that the initial outline sketch is void of color and texture present in the static illustration; and
generate the set of outline sketches as a texture-agnostic video sequence devoid of the color and texture present in the static illustration.

11. The system of claim 1, wherein:
the AI model is trained on a sample set of anime data; and
the sequence of animation frames is characterized by an anime style of animation.

12. A method comprising:
generating, by circuitry, a mesh representation of a segment of an object present in a static illustration;
simulating, by the circuitry, motion of the mesh representation by generating a sequence of optical flow fields;
extracting, by the circuitry, an initial outline sketch of the object from the static illustration;
generating, by the circuitry, a set of outline sketches that represent the simulated motion by warping the initial outline sketch based at least in part on the sequence of optical flow fields; and
applying, by the circuitry, an artificial intelligence (AI) model to transform the set of outline sketches into a sequence of animation frames that collectively demonstrate the simulated motion.

13. The method of claim 12, further comprising receiving input indicating one or more external forces to be applied to the mesh representation, wherein simulating the motion of the mesh representation comprises:
applying, to the mesh representation, a model of deformable body dynamics that accounts for the input; and
generating the sequence of optical flow fields based at least in part on an output of the model of deformable body dynamics.

14. The method of claim 13, wherein:
the input further indicates one or more rigging points of the object; and
the external forces comprise at least one of:
wind;
gravity; or
user-defined energy strokes.

15. The method of claim 12, further comprising analyzing the static illustration to separate a plurality of segments of the object relative to one another, wherein generating the mesh representation comprises:
generating a first two-dimensional triangulated mesh representation of a first segment included in the plurality of segments; and
generating a second two-dimensional triangulated mesh representation of a second segment included in the plurality of segments.

16. The method of claim 15, wherein:
simulating the motion of the mesh representation comprises simulating motion of the first two-dimensional triangulated mesh representation by generating a first sequence of optical flow fields;
generating the set of outline sketches comprises generate a first set of outline sketches that represent the simulated motion of the first two-dimensional triangulated mesh representation by warping the initial outline sketch based at least in part on the first sequence of optical flow fields; and
applying the AI model comprises applying the AI model to transform the first set of outline sketches into a first sequence of animation frames that collectively demonstrate the simulated motion of the first two-dimensional triangulated mesh representation.

17. The method of claim 16, wherein:
simulating the motion of the mesh representation comprises simulating motion of the second two-dimensional triangulated mesh representation by generating a second sequence of optical flow fields;
generating the set of outline sketches comprises generating a second set of outline sketches that represent the simulated motion of the second two-dimensional triangulated mesh representation by warping the initial outline sketch based at least in part on the second sequence of optical flow fields; and
applying the AI model comprises applying the AI model to transform the second set of outline sketches into a second sequence of animation frames that collectively demonstrate the simulated motion of the second two-dimensional triangulated mesh representation.

18. The method of claim 12, further comprising:
interpolating at least one additional frame based at least in part on the sequence of animation frames; and
placing the additional frame between two frames included in the sequence of animation frames to enhance fluidity of animation.

19. The method of claim 18, wherein interpolating the additional frame by applying a cartoon interpolation model to introduce:
non-physical dynamics that do not follow physical laws in the sequence of animation frames; or
expressive dynamics that show exaggerated motion in the sequence of animation frames.

20. A non-transitory computer-readable medium comprising one or more computer-executable instructions that, when executed by circuitry of at least one computing device, cause the computing device to:
generate a mesh representation of a segment of an object present in a static illustration;
simulate motion of the mesh representation by generating a sequence of optical flow fields;
extract an initial outline sketch of the object from the static illustration;
generate a set of outline sketches that represent the simulated motion by warping the initial outline sketch based at least in part on the sequence of optical flow fields; and
apply an artificial intelligence (AI) model to transform the set of outline sketches into a sequence of animation frames that collectively demonstrate the simulated motion.
